(19) United States
(12) Patent Application Publication
(10) Pub. No.: US 2017/0355564 A1
(43) Pub. Date: Dec. 14, 2017

(54) ELEVATOR SYSTEM

(71) Applicants: Guillaume BONATRE, Gien (FR); OTIS ELEVATOR COMPANY, Farmington, CT (US)

(72) Inventor: Guillaume Bonatre, Ousson sur Loire (FR)

(21) Appl. No.: 15/536,266

(22) PCT Filed: Jun. 11, 2015
(86) PCT No.: PCT/IB2015/001125

§ 371 Date: Jun. 15, 2017

(30) Foreign Application Priority Data
Dec. 23, 2014 (IB) PCT/IB2014/003127

(51) Int. Cl. B66B 11/00; B66B 11/02; F24F 7/007

(52) U.S. Cl. CPC B66B 11/0005; B66B 11/024; F24F 7/007

(57) ABSTRACT

An elevator system 20 is provided including a hoistway 33 that does not include a ventilation opening 50 configured to fluidly couple to the hoistway to an air source disposed outside of the hoistway. An elevator car 24 is movable within the hoistway between a plurality of landings 27. A plurality of landing doors 26 is arranged at each of the plurality of landings. The landing doors are movable between an open position and a closed position. The plurality of landing doors is configured to allow a defined amount of fluid flow there through when in a closed position.

### CROSS-REFERENCE TO RELATED APPLICATIONS

This application claims priority to International Patent Application No. PCT/IB2014/003127 (formerly PCT/FR2014/053535) filed Dec. 23, 2014, the entire contents of which are incorporated herein by reference.

### BACKGROUND

Embodiments of the disclosure relate to an elevator system, and more particularly, to a ventilation system of an elevator system configured to reduce energy waste.

Existing regulations require that an elevator system includes both hoistway ventilation and car ventilation for mechanic and passenger health and safety in all circumstances including shut down resulting in entrapment. With respect to hoistway ventilation, conventional systems typically include a ventilation opening generally formed near the top of the hoistway to fluidly connect the hoistway to an outside air source. Other systems may be connected to an air conditioning system of the building such that a flow of air is forced into or through the hoistway.

With the advancement of global warming and increasing energy costs, there is a desire to minimize the amount of energy consumed by both new and existing buildings. Conventional ventilation systems of an elevator, however, tend to be conservatively designed and implemented and therefore result in significant energy losses for the building. For example, conditioned air within the building may escape through the opening formed at the top of the hoistway resulting in a loss of heat and energy.

### BRIEF DESCRIPTION OF THE DISCLOSURE

According to one embodiment of the disclosure, an elevator system is provided including a hoistway that does not include a ventilation opening configured to fluidly couple to the hoistway to an air source disposed outside of the hoistway. An elevator car is movable within the hoistway between a plurality of landings. A plurality of landing doors is arranged at each of the plurality of landings. The landing doors are movable between an open position and a closed position. The plurality of landing doors is configured to allow a defined amount of fluid flow there through when in a closed position.

In addition to one or more of the features described above, or as an alternative, in further embodiments the defined amount of fluid flow reduces energy losses as a result of fluid flow through the landing doors.

In addition to one or more of the features described above, or as an alternative, in further embodiments each of the plurality of landing doors is configured to allow a defined amount of fluid flow there through by optimizing at least one of a shape and size of at least one gap formed in therein.

In addition to one or more of the features described above, or as an alternative, in further embodiments each of the plurality of landing doors includes one or more door panels. The shape and size of the at least one gap being determined by a deflection of the one or more door panels.

In addition to one or more of the features described above, or as an alternative, in further embodiments the deflection of the one or more door panels occurs in response to pressure variations within the hoistway.

In addition to one or more of the features described above, or as an alternative, in further embodiments the deflection of the one or more door panels is determined by a thickness of the one or more door panels.

In addition to one or more of the features described above, or as an alternative, in further embodiments the deflection of the one or more door panels is determined by a material used to form the one or more door panels.

In addition to one or more of the features described above, or as an alternative, in further embodiments the deflection of the one or more door panels is determined by a shape of the one or more door panels.

In addition to one or more of the features described above, or as an alternative, in further embodiments a stiffener is used to limit the deflection of the one or more door panels.

In addition to one or more of the features described above, or as an alternative, in further embodiments a retainer is used to limit the deflection of the one or more door panels.

In addition to one or more of the features described above, or as an alternative, in further embodiments the at least one gap of each of the plurality of landing doors includes at least one of a vertical gap and a horizontal gap.

In addition to one or more of the features described above, or as an alternative, in further embodiments the vertical gap is formed between a door column and one of the one or more door panels.

In addition to one or more of the features described above, or as an alternative, in further embodiments the one or more door panels includes a first door panel and a second door panel, the vertical gap is formed between the first door panel and the second door panel.

In addition to one or more of the features described above, or as an alternative, in further embodiments the horizontal gap is formed between the one or more door panels and at least one of a door sill and a door lintel.

In addition to one or more of the features described above, or as an alternative, in further embodiments wherein the elevator car further comprises at least one air scoop configured to fluidly couple an interior of the elevator car to the hoistway such that a controlled fluid flow may pass there between.

In addition to one or more of the features described above, or as an alternative, in further embodiments the air scoop includes a first portion having an enlarged opening configured as an air intake or outtake.

In addition to one or more of the features described above, or as an alternative, in further embodiments the at least one air scoop is mounted to a wall structure of the elevator car.

In addition to one or more of the features described above, or as an alternative, in further embodiments the at least one air scoop is arranged within a door column of the wall structure.

In addition to one or more of the features described above, or as an alternative, in further embodiments the at least one air scoop is mounted to roof of the elevator car.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an elevator system according to an embodiment of the disclosure;

FIG. 2 is a perspective view of another elevator system according to an embodiment of the disclosure;

FIG. 3a is a front view of an example of a landing door according to an embodiment of the disclosure;

FIG. 3b is a top view of the landing door of FIG. 3a according to an embodiment of the disclosure;

FIG. 3c is a side view of the landing door of FIG. 3a according to an embodiment of the disclosure;

FIG. 4 is a perspective view of an elevator car of the elevator system of FIGS. 1 and 2 according to an embodiment of the disclosure;

FIG. 5 is a perspective view of a portion of an elevator frame of the elevator car of FIG. 4 including an air scoop according to an embodiment of the disclosure; and

FIG. 6 is a perspective view of a portion of an elevator frame of the elevator car of FIG. 4 including an air scoop according to an embodiment of the disclosure.

The detailed description explains embodiments of the disclosure, together with advantages and features, by way of example with reference to the drawings.

### DETAILED DESCRIPTION

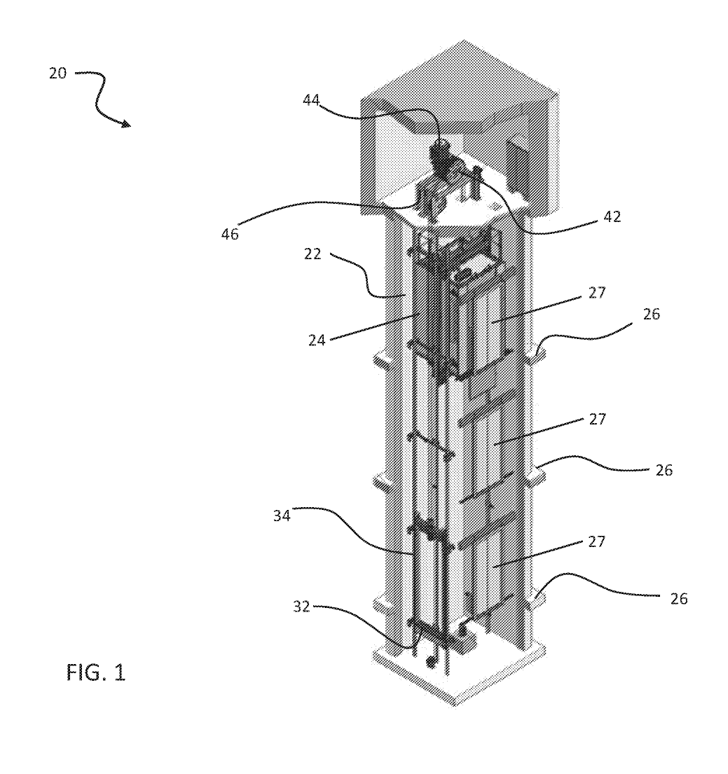

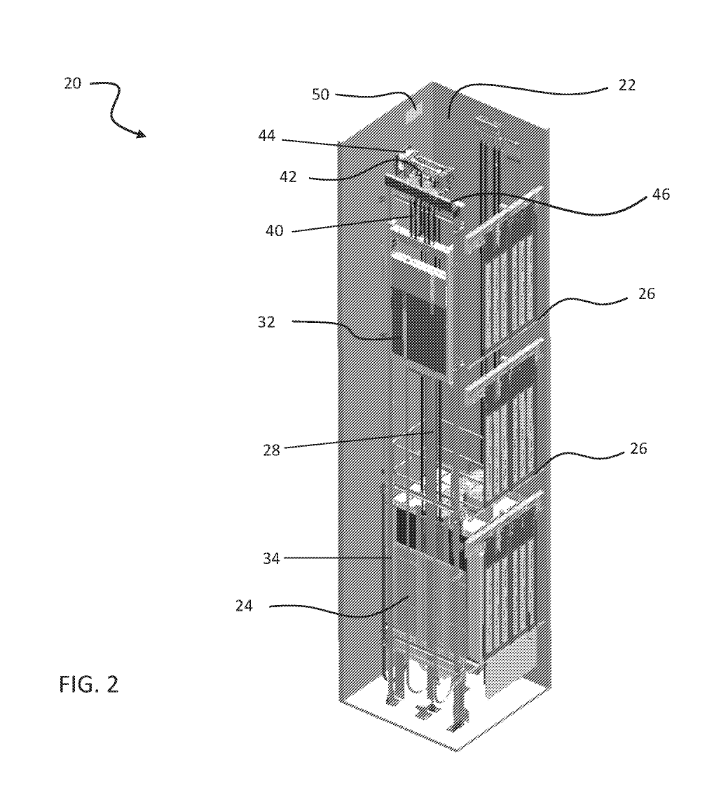

Referring now to FIGS. 1 and 2, examples of an elevator system 20 resulting in reduced energy losses for a building are illustrated. In the illustrated, non-limiting embodiment, the elevator system 20 includes an elevator car 24 configured to move vertically upwardly and downwardly within a hoistway 22 between two or more landings 26 along car guide members 28, for example car guide rails. The hoistway 22 may be fully enclosed, or only partially enclosed, such as when the elevator system 20 is positioned within an atrium for example. Guide assemblies (not shown) mounted to the top and bottom of the elevator car 24 are configured to engage the car guide members 28 to maintain proper alignment of the elevator car 24 as it moves within the hoistway 22.

The elevator system 20 additionally includes a counterweight 32 configured to move vertically upwardly and downwardly within the hoistway 22. The counterweight 32 moves in a direction generally opposite the movement of the elevator car 24 as is known in conventional elevator systems. Movement of the counterweight 32 is guided by counterweight guide members 34 mounted within the hoistway 22. In the illustrated, non-limiting embodiment of FIG. 2, the elevator car 24 and counterweight 32 include sheave assemblies (not shown) configured to cooperate with at least one load bearing member 40 and a traction sheave 42 mounted to a drive machine 44 to raise and lower the elevator car 24. The drive machine 44 in the illustrated embodiment of the disclosure is suited and sized for use with flat, belt-like load bearing members 40. However, other load bearing members 40, such as steel or composite ropes or cables for example, are within the scope of the disclosure, too. In the system of FIG. 2, the sheave assemblies (not shown) are mounted at the bottom of the elevator car 24, in an underslung configuration. However, the one or more sheave assemblies may be mounted at another location on the elevator car 24, such as the top of the elevator car 24 for example, or elsewhere in the system 20 as recognized by a person skilled in the art.

The drive machine 44 of the elevator system 20 is positioned and supported at a mounting location atop a support member 46, such as a bedplate for example, in a portion of the hoistway 22 (FIG. 2) or in a machine room (FIG. 1). In other embodiments, the machine 44 may be located at other positions within the hoistway 22, such as within a pit for example. Although the elevator system 20 illustrated and described in FIG. 1 has a 1:1 roping and the elevator system of FIG. 2 has an underslung 2:1 roping configuration, elevator systems 20 having other roping configurations and/or hoistway layouts are within the scope of the disclosure. In addition, other elevator systems including hydraulic and linear motor systems are within the scope of the disclosure.

To reduce or minimize the energy losses of the building, the elevator systems 20 as shown in FIG. 1, does not include a ventilation opening formed in a portion of the hoistway 22 to continuously fluidly connect the hoistway 22 to an external air source for receiving or exhausting air. Similarly, the hoistway 22 is not connected to a heating, ventilation, and air conditioning (HVAC) system of the building. As a result, air from the HVAC system is not provided to the hoistway 22 or elevator car 24, and air from the hoistway 22 or elevator car 24 is not provided to the HVAC system. However, in other embodiments, the hoistway 22 or elevator car 24 may be selectively coupled to an air source. In such embodiments, a cover 50 may be configured to move between a first position and a second position relative to an adjacent ventilation opening to control a flow of air into or out of the elevator system 20.

It has been determined that the presence or absence of a ventilation opening 50 in the hoistway 22 does not influence the flow of air through the plurality of landing doors 27. Therefore, in embodiments, where the hoistway 22 does not include a ventilation opening 50, the landing doors 27 may be configured to allow a desired amount of fluid flow there through, both into and out of the hoistway 22, when in a closed position. For example, the desired amount of air may be at least the minimum air flow requirement dictated by one or more elevator and building code authorities. More specifically, the landing doors 27 may be optimized such that in combination, the minimum amount of airflow required is able to pass through the closed landing doors 27 and into the hoistway 22, such that the building does not incur unnecessary energy losses from the elevator system 20.

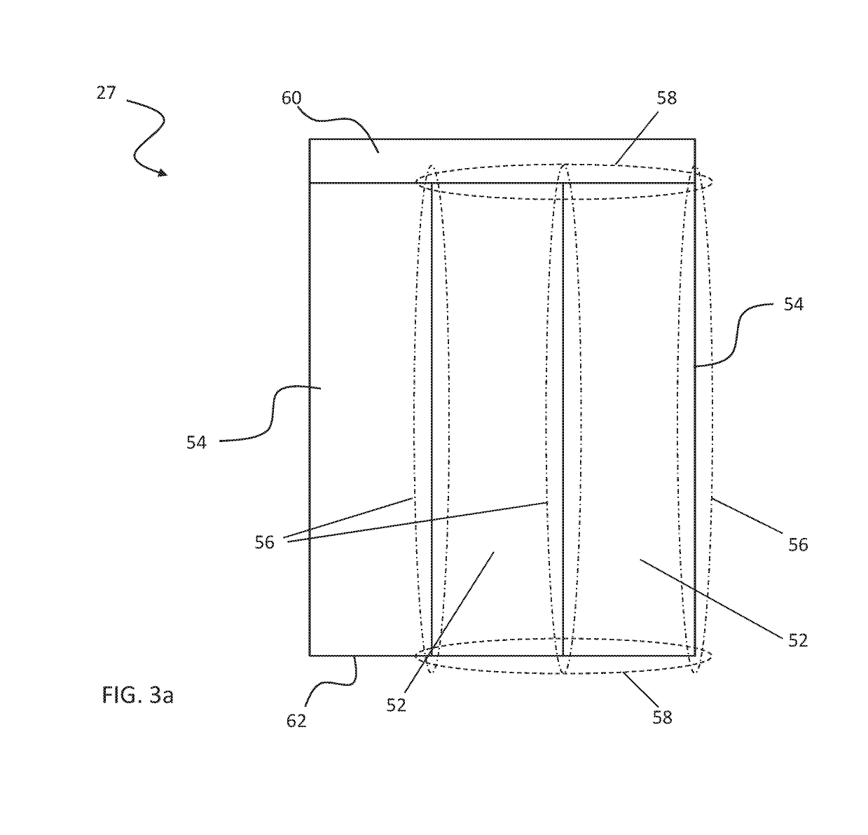

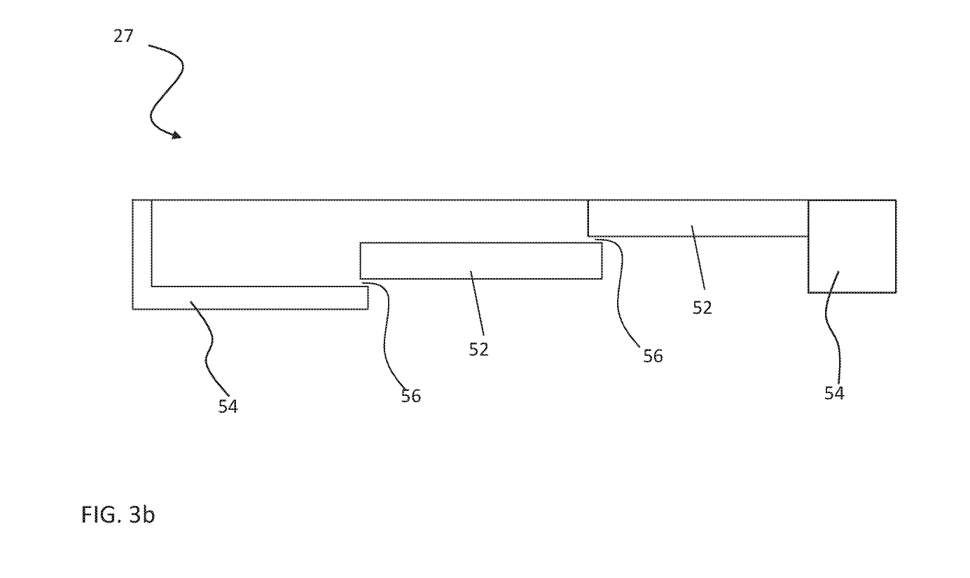

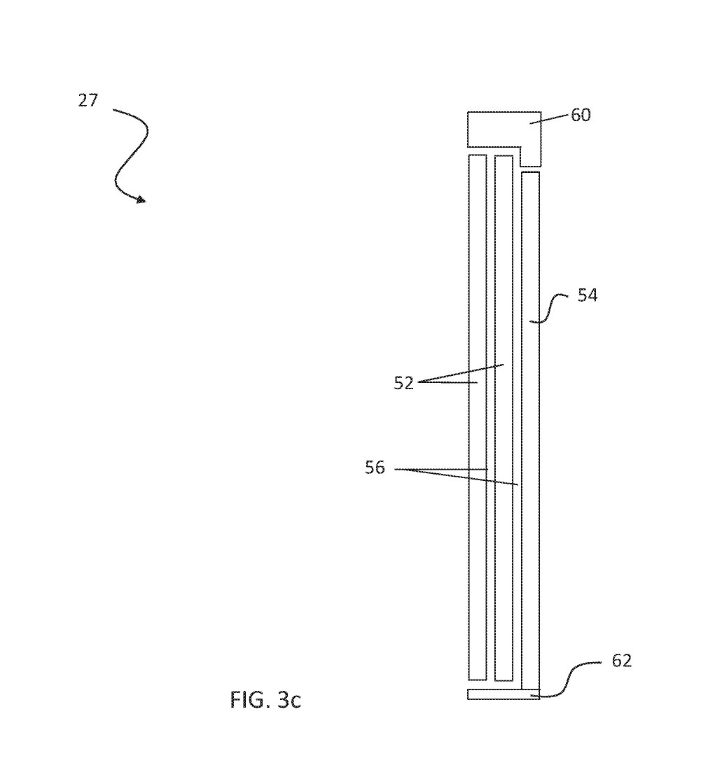

Referring now to FIGS. 3a-3c, an example of one configuration of the landing doors 27 arranged at a landing 26 within the hoistway 22 is illustrated in more detail. As shown, the landing doors 27 include a side opening door having two telescoping door panels 52 mounted between opposing door columns 54. During operation of the illustrated landing doors 27, the door panels 52 are configured to slide into an overlapping position adjacent one of the door columns 54 to create an opening leading into an adjacent elevator car 24. Although a landing door 27 having a plurality of telescoping door panels 52 is illustrated and described herein, landing doors 27 having any configuration, including center opening landing doors and landing doors with any number of door panels 52 are within the scope of the disclosure.

As best illustrated in FIGS. 3b and 3c, a vertical gap 56 extending generally over the full height of the door panels 52 exists not only between a door column 54 and an adjacent door panel 52, but also between adjacent door panels 52. In addition, laterally oriented gaps 58 exist between the movable door panels 52 and the lintel 60, as well as between the door panels 52 and the door sill 62 (see FIG. 3a). Each of gaps 56 and 58 allows a flow of air or another fluid into and out of the hoistway 22.

In one embodiment, a desired air flow is achieved by optimizing the size of at least one gap 56, 58 formed in the landing doors 27. Due to the movement of the door panels 52 relative to the lintel 60 and door sill 62, adjustment of the lateral gaps 58 is difficult without affecting the operation of the landing door 27. The size of the plurality of vertical gaps 56, however, may be more easily modified to control a volume of air flow through the landing doors 27.

When the elevator car 24 is stationary, a natural chimney effect occurs within the hoistway 22 such that due to the difference in height, the pressure exerted on each set of landing doors 27 varies. In addition, during operation of the elevator system 20, the movement of the elevator car 24 throughout the hoistway 22 creates a piston effect. The pressure generated at the front of the elevator car 24 forces air from the hoistway 22 through the landing doors 27 to the landing 26, and the pressure generated at the rear of the elevator car 24 draws air from the landing 26, through the landing doors 27, and into the hoistway 22.

In response to this pressure, the door panels 52 are configured to deflect or elastically deform, thereby altering the size and/or shape of at least one of the gaps 56 in the landing doors 27. The door panels 52 may therefore be designed such that a desired amount of deflection occurs for a given pressure. A desired amount of deflection of the door panels 52 may be achieved in a variety of ways, including, but not limited to adjusting a thickness of the door panel 52, the type of material used to form the door panel 52, or a shape or contour of the door panel 52. In addition, stiffeners may be added at one or more locations to the door panel 52 and/or retainers may be used to block or limit the deformation of the door panels 52. By designing the door panels 52 to deflect a certain amount and/or in a certain direction when a known pressure is applied thereto, the size and shape of the gaps 56 in the landing doors 27, and therefore the air flow through the closed landing doors 27 may be optimized.

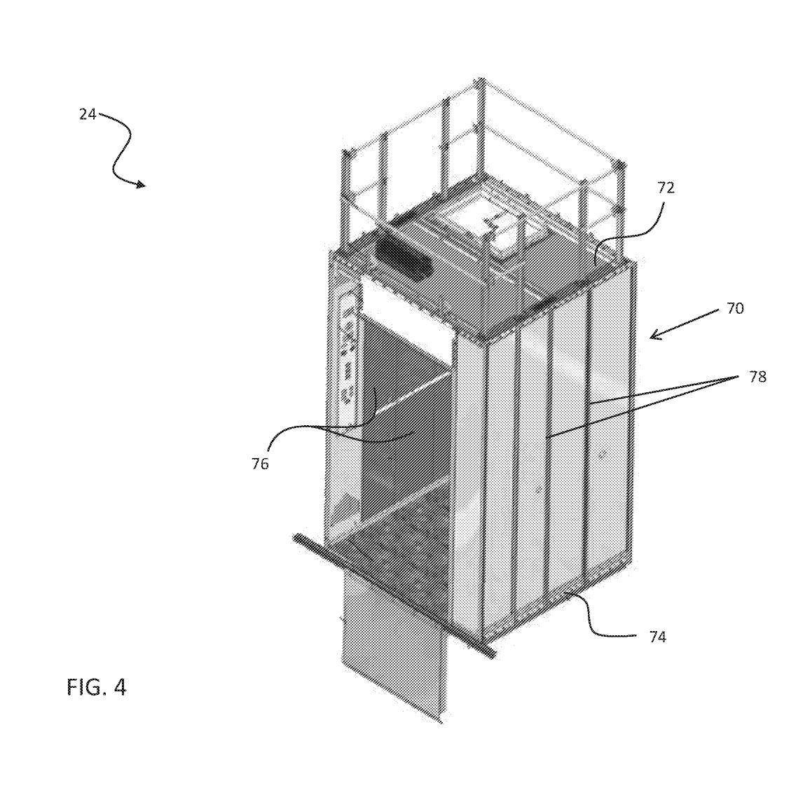

In addition to optimizing the air flow through the landing doors 27, adjustments may be made to improve the air flow into and out of the elevator car 24. Referring now to FIG. 4, an example of an elevator car 24 configured for use in an elevator system 20 resulting in reduced energy losses for a building is illustrated in more detail. The elevator car 24 includes a wall structure 70 extending between a car roof 72 and a car floor 74. In one embodiment, the wall structure 70 includes a plurality of car panels 76 mounted to vertical supports 78 configured to provide the necessary stiffness to the car panels 76. In another embodiment, the plurality of car panels 76 themselves may form the wall structure 70 of the elevator car 24. In addition, a lining (not shown) may be attached to an interior surface of the car panels 76 to provide an aesthetically desirable appearance.

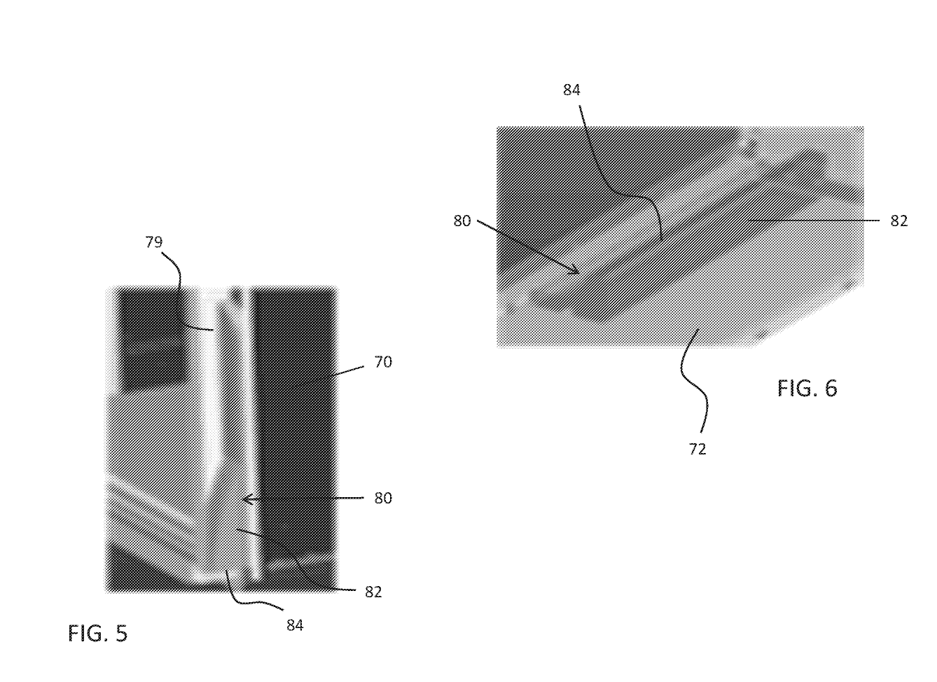

Referring now to FIGS. 5 and 6, the ventilation system of the elevator system 20 may further include at least one air scoop 80 mounted to a portion of the elevator car 24. The one or more air scoops 80 may be attached to the wall structure 70 of the elevator car 24, for example near the bottom thereof as shown in FIG. 5. In one embodiment, the air scoop 80 is positioned within the portion of the wall structure 70 that forms a door column 79 configured to receive an elevator car door (not shown) when in the open position for example. Alternatively, or in addition, one or more air scoops 80 may be attached to an upper portion of the wall structure 70, such as near the car roof 72 for example. As shown in FIG. 6, an air scoop 80 may be mounted to a portion of the car roof 72 at any position, such as near a center of the car roof 72 for example. In embodiments including more than one air scoop 80, the air scoops may be substantially identical, or different.

The air scoops 80 are generally formed from a lightweight plastic, metal, composite or other suitable material having a fluid channel extending there through. The shape and size of the air scoop 80 is designed to optimize the amount of air flow between the hoistway 22 and the interior of the elevator car 24. In the illustrated, non-limiting embodiment, a first portion 82 of the air scoop 80 has an enlarged opening 84, configured as an air intake, to increase the amount of air drawn from the hoistway 22 into the scoop 80. Alternatively, the enlarged opening 84 may be configured as an air outtake to draw air or carbon dioxide from the elevator car 24 and into the hoistway 22.

The one or more air scoops 80 affixed to the elevator car 24 are intended to provide a controlled flow of air from the hoistway 22 into the interior of the elevator car 24. The controlled air flow provided by the one or more scoops 80, in combination with the gaps or openings adjacent the car doors, satisfies the “effective area of ventilation apertures” situated within either an upper portion or a lower portion of the elevator car 24 as required by elevator code authorities or other regulations, such as the Lift Directive 95/16/CE under ESR 4.7 of Annex I for example.

The elevator system 20 described herein provides the benefit of improving the energy efficiency of a building by eliminating the need for a connection between the hoistway 22 and an air supply. Rather, the plurality of landing doors 27 may be designed to allow only a necessary amount of air flow into and out of the hoistway to minimize energy losses.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. An elevator system, comprising
a hoistway, wherein the hoistway does not include a ventilation opening configured to continuously fluidly couple the hoistway to an air source disposed outside of the hoistway;
an elevator car movable within the hoistway between a plurality of landings; and
a plurality of landing doors, each landing door being arranged at one of the plurality of landings and being movable between an open position and a closed position, wherein the plurality of landing doors is configured to allow a defined amount of fluid flow there through when in a closed position.

2. The elevator system according to claim 1, wherein the defined amount of fluid flow reduces energy losses as a result of fluid flow through the landing doors.

3. The elevator system according to claim 1, wherein each of the plurality of landing doors is configured to allow a defined amount of fluid flow there through by optimizing at least one of a shape and size of at least one gap formed in therein.

4. The elevator system according to claim 3, wherein each of the plurality of landing doors includes one or more door panels, the at least one of the shape and size of the at least one gap being determined by a deflection of the one or more door panels.

5. The elevator system according to claim 4, wherein the deflection of the one or more door panels occurs in response to pressure variations within the hoistway.

6. The elevator system according to claim 4, wherein the deflection of the one or more door panels is determined by a thickness of the one or more door panels.

7. The elevator system according to claim 4, wherein the deflection of the one or more door panels is determined by a material used to form the one or more door panels.

8. The elevator system according to claim 4, wherein the deflection of the one or more door panels is determined by a shape of the one or more door panels.

9. The elevator system according to claim 4, wherein a stiffener is used to limit the deflection of the one or more door panels.

10. The elevator system according to claim 4, wherein a retainer is used to limit the deflection of the one or more door panels.

11. The elevator system according to claim 4, wherein the at least one gap of each of the plurality of landing doors includes at least one of a vertical gap and a horizontal gap.

12. The elevator system according to claim 11, wherein the vertical gap is formed between a door column and one of the one or more door panels.

13. The elevator system according to claim 11, wherein the one or more door panels includes a first door panel and a second door panel, the vertical gap is formed between the first door panel and the second door panel.

14. The elevator system according to claim 11, wherein the horizontal gap is formed between the one or more door panels and at least one of a door sill and a door lintel.

15. The elevator system according to claim 1, wherein the elevator car further comprises at least one air scoop configured to fluidly couple an interior of the elevator car to the hoistway such that a controlled fluid flow may pass there between.

16. The elevator system according to claim 15, wherein the air scoop includes a first portion having an enlarged opening configured as an air intake or outtake.

17. The elevator system according to claim 13, wherein the at least one air scoop is mounted to a wall structure of the elevator car.

18. The elevator system according to claim 15, wherein the at least one air scoop is arranged within a door column of the wall structure.

19. The elevator system according to claim 13, wherein the at least one air scoop is mounted to roof of the elevator car.
